(19) United States
(12) Patent Application Publication
(10) Pub. No.: US 2018/0162693 A1
(43) Pub. Date: Jun. 14, 2018

(54) SPEED DETECTION MEANS FOR ELEVATOR OR COUNTERWEIGHT

(71) Applicant: OTIS ELEVATOR COMPANY, Farmington, CT (US)

(72) Inventor: Guohong Hu, Farmington, CT (US)

(21) Appl. No.: 15/377,450

(22) Filed: Dec. 13, 2016

(51) Int. Cl. B66B 5/04; B66B 5/22

(52) U.S. Cl. CPC B66B 5/044; B66B 9/00; B66B 5/22

(57) ABSTRACT

A speed detection device for a braking device in an elevator system including an elevator car and a guide rail operable in a hoistway. The speed detection device includes a safety actuation device having a first guide member disposed on a mounting plate and a second guide member disposed on the mounting plate, the first and second guide members in operable communication with the guide rail, and the mounting plate is slidingly engaged with a car frame of the elevator car. The speed detection device also includes a first rotary encoder disposed on the mounting plate and operably connected to the first guide member, and a preload mechanism operably engaged with the second guide member and configured to slidingly displace the second guide member and the safety actuation device so that the second guide member and the first guide member maintain contact with the guide rail.

### TECHNICAL FIELD OF THE DISCLOSED EMBODIMENTS

The present disclosure is generally related to braking and/or safety systems and, more specifically, to a speed detection apparatus for an electronic safety actuator for an elevator.

### BACKGROUND OF THE DISCLOSED EMBODIMENTS

Some machines, such as an elevator system, include a safety system to stop the machine when it rotates at excessive speeds or the elevator cab travels at excessive speeds. When operating at higher speeds, it becomes important to have accurate timely speed information to ensure timely braking performance and other overall performance factors within the system. There is therefore a need for a more robust safety system with more accurate speed detection systems.

### BRIEF SUMMARY OF THE EMBODIMENTS

In one aspect described herein in an embodiment is a speed detection device for a braking device in an elevator system including an elevator car and a guide rail operable in a hoistway. The speed detection device includes a safety actuation device having a first guide member disposed on a mounting plate and a second guide member disposed on the mounting plate, the first and second guide members in operable communication with the guide rail, and the mounting plate is slidingly engaged with a car frame of the elevator car. The speed detection device also includes a first rotary encoder disposed on the mounting plate and operably connected to the first guide member, and a preload mechanism operably engaged with the second guide member and configured to slidingly displace the second guide member and the safety actuation device so that the second guide member and the first guide member maintain contact with the guide rail.

In addition to one or more of the features described above, or as an alternative, further embodiments may include a third guide member disposed on the mounting plate of the safety actuation device and a fourth guide member disposed on the mounting plate, the third guide member and the fourth guide member in operable communication with the guide rail as the elevator car moves along the guide rail in the hoistway.

In addition to one or more of the features described above, or as an alternative, further embodiments may include a second rotary encoder disposed on the mounting plate and operably connected to the third guide member.

In addition to one or more of the features described above, or as an alternative, further embodiments may include a second preload mechanism operably engaged with the fourth guide member and configured to slidingly displace the fourth guide member and the safety actuation device so that the fourth guide member and the third guide member maintain contact with the guide rail.

In addition to one or more of the features described above, or as an alternative, further embodiments may include that the third guide member and the fourth guide member are displaced vertically on the safety actuation device from the first guide member and the second guide member.

In addition to one or more of the features described above, or as an alternative, further embodiments may include that the first guide member is a roller.

In addition to one or more of the features described above, or as an alternative, further embodiments may include that the second guide member is at least one of a roller and a slide.

In addition to one or more of the features described above, or as an alternative, further embodiments may include that the first rotary encoder is at least one of electromagnetic and optical.

In addition to one or more of the features described above, or as an alternative, further embodiments may include that the preload mechanism includes at least one of a spring and a magnetic assembly.

In addition to one or more of the features described above, or as an alternative, further embodiments may include that the safety actuation device floats horizontally with respect to the elevator car.

Also described herein in another embodiment is a braking device for an elevator system including an elevator car and a guide rail configured to operate in a hoistway. The braking device including a safety brake disposed on the car and adapted to be wedged against the guide rail when moved from a non-braking state into a braking state, and a safety actuation device disposed on the elevator car, the safety actuation device including a first electromagnetic actuator and a second electromagnetic actuator, the first electromagnetic actuator and the second electromagnetic actuator operably coupled to the safety brake, wherein actuation of at least one of the first electromagnetic actuator and the second electromagnetic actuator causes movement of the safety brake from the non-braking state into the braking state, a first guide member disposed on a mounting plate of the safety actuation device and a second guide member disposed on the mounting plate, the first guide member and the second guide member in operable communication with the guide rail as the elevator car moves along the guide rail in the hoistway, wherein the mounting plate is slidingly engaged in a horizontal axis with a car frame of the elevator car, a first encoder disposed on the mounting plate and operably connected to the first guide member, the first encoder configured to measure the displacement of the safety actuation device and thereby the elevator car as the elevator car moves along the guide rail in the hoistway, and a preload mechanism operably engaged with the second guide member and configured to slidingly displace the second guide member and the safety actuation device so that the second guide member and the first guide member maintain contact with the guide rail. The braking device also including a controller in operable communication with at least one of the first electromagnetic actuator as well as the first encoder, the controller responsive to the encoder and configured to provide an actuation command to at least one of the first electromagnetic actuator and second electromagnetic actuator.

In addition to one or more of the features described above, or as an alternative, further embodiments may include a third guide member disposed on the mounting plate of the safety actuation device and a fourth guide member disposed on the mounting plate, the third guide member and the fourth guide member in operable communication with the guide rail as the elevator car moves along the guide rail in the hoistway.

In addition to one or more of the features described above, or as an alternative, further embodiments may include a second rotary encoder disposed on the mounting plate and operably connected to the third guide member.

In addition to one or more of the features described above, or as an alternative, further embodiments may include a second preload mechanism operably engaged with the fourth guide member and configured to slidingly displace the fourth guide member and the safety actuation device so that the fourth guide member and the third guide member maintain contact with the guide rail.

In addition to one or more of the features described above, or as an alternative, further embodiments may include that the third guide member and the fourth guide member are displaced vertically on the safety actuation device from the first guide member and the second guide member.

Also described herein in yet another embodiment is an elevator system. The elevator system including a hoistway, a guide rail disposed in the hoistway, a car operably coupled to the guide rail by a car frame for upward and downward travel in the hoistway, and a safety brake disposed on the car and adapted to be wedged against the guide rail when moved from a non-braking state into a braking state. The elevator system also includes a safety actuation device disposed on the elevator car, the safety actuation device including; a first electromagnetic actuator and a second electromagnetic actuator, the first electromagnetic actuator and the second electromagnetic actuator operably coupled to the safety brake, wherein actuation of at least one of the first electromagnetic actuator and the second electromagnetic actuator causes movement of the safety brake from the non-braking state into the braking state, a first guide member disposed on a mounting plate of the safety actuation device and a second guide member disposed on the mounting plate, the first guide member and the second guide member in operable communication with the guide rail as the elevator car moves along the guide rail in the hoistway, wherein the mounting plate is slidingly engaged in a horizontal axis with a car frame of the elevator car, a first encoder disposed on the mounting plate and operably connected to the first guide member, the first encoder configured to measure the displacement of the safety actuation device and thereby the elevator car as the elevator car moves along the guide rail in the hoistway, and a preload mechanism operably engaged with the second guide member and configured to slidingly displace the second guide member and the safety actuation device so that the second guide member and the first guide member maintain contact with the guide rail. The elevator system also including a controller in operable communication with at least one of the first electromagnetic actuator as well as the first encoder, the controller responsive to the encoder and configured to provide an actuation command to at least one of the first electromagnetic actuator and second electromagnetic actuator.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic diagram of an elevator system employing a mechanical governor;

FIG. 2 is a perspective view of an electronic safety actuator and safety brake according to an embodiment of the present disclosure;

FIG. 3 is a partial perspective view of the electronic safety actuator with a speed detection mechanism according to an embodiment of the present disclosure; and

FIG. 4 depicts a partially exploded cutaway view of the upper portion of a safety actuation device shown looking downward according to an embodiment of the present disclosure.

### DETAILED DESCRIPTION OF THE EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The following description is merely illustrative in nature and is not intended to limit the present disclosure, its application or uses. It should be understood that throughout the drawings, corresponding reference numerals indicate like or corresponding parts and features. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in Figure X may be labeled “Xa” and a similar feature in Figure Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

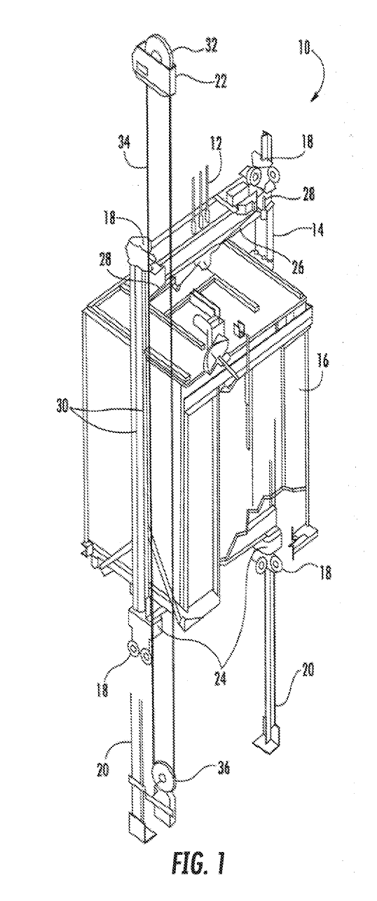

FIG. 1 shows an elevator system, generally indicated at 10. The elevator system 10 includes cables 12, a car frame 14, an elevator car 16, roller guides 18, guide rails 20, a governor 22, safety brake 24, linkages 26, levers 28, and lift rods 30. Governor 22 includes a governor sheave 32, rope loop 34, and a tensioning sheave 36. Cables 12 are connected to car frame 14 and a counterweight (not shown in FIG. 1) inside a hoistway. Elevator car 16, which is attached to car frame 14, moves up and down the hoistway by force transmitted through cables or belts 12 to car frame 14 by an elevator drive (not shown) commonly located in a machine room at the top of the hoistway. Roller guides 18 are attached to car frame 14 to guide the elevator car 16 up and down the hoistway along guide rail 20. Governor sheave 32 is mounted at an upper end of the hoistway. Rope loop 34 is wrapped partially around governor sheave 32 and partially around tensioning sheave 36 (located in this embodiment at a bottom end of the hoistway). Rope loop 34 is also connected to elevator car 16 at lever 28, ensuring that the angular velocity of governor sheave 32 is directly related to the speed of elevator car 16.

In the elevator system 10 shown in FIG. 1, governor 22, an electromechanical brake (not shown) located in the machine room, and the safety brake 24 acts to stop elevator car 16 if it exceeds a set speed as it travels inside the hoistway. If elevator car 16 reaches an over-speed condition, governor 22 is triggered initially to engage a switch, which in turn cuts power to the elevator drive and activates the brake to arrest movement of the drive sheave (not shown) and thereby arrest movement of elevator car 16. If, however, the elevator car 16 continues to experience an over speed condition, governor 22 may then act to trigger the safety brake 24 to arrest movement of elevator car 16. In addition to engaging a switch to activate the brake, governor 22 also releases a clutching device that grips the governor rope 34. Governor rope 34 is connected to the safety brake 24 through mechanical linkages 26, levers 28, and lift rods 30. As elevator car 16 continues its descent unaffected by the brake, governor rope 34, which is now prevented from moving by actuated governor 22, pulls on operating lever 28. Operating lever 28 “sets” the safety brake 24 by moving linkages 26 connected to lift rods 30, which lift rods 30 cause the safety brake 24 to engage guide rails 20 to bring elevator car 16 to a stop.

Mechanical speed governor systems are being replaced in some elevators by electronic systems. Existing electronic safety actuators mainly employ primarily asymmetric safety brake configurations. These devices typically have a single sliding wedge forceably engaging the elevator guide rail 20 and are usually employed for low and mid speed applications. However, for high speed elevator systems, symmetric safety brakes that have two sliding wedges to engage the guide rail 20 of the elevator system 10 may become necessary. Performance of electronic elevator safety actuation devices that are suitable for actuating and resetting symmetric safety brakes 24 rely on accurate measurement of the speed of the elevator car to ensure that the safety brake 24 is properly applied or not applied. Therefore, disclosed herein is an electronic safety actuator with an integrated speed detection mechanism that ensures accurate, reliable measurement of the speed of the elevator car 16 for low and high speed applications.

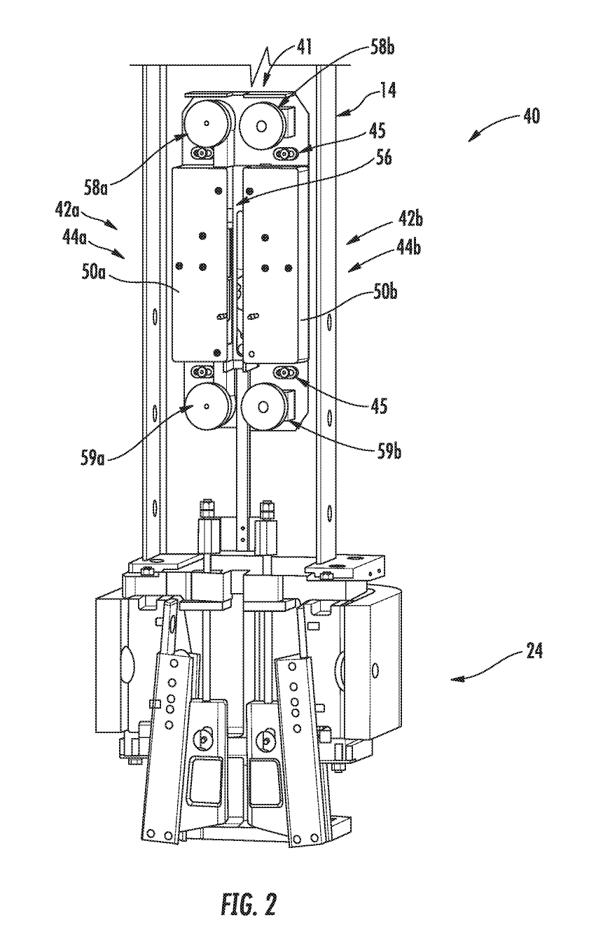

FIG. 2 shows an embodiment of an assembly for a safety actuation device 40 affixed to the car frame 14 (typically on the sides of the elevator car 16). In an embodiment the safety actuation device 40 includes a mounting plate 41 with the electromagnetic actuators shown generally as 42a, 42b with magnetic brake pads shown generally as 44a, 44b affixed to the mounting plate 41 within a housing 50. It will be appreciated that the reference numerals with the “a” are depicted to the left when looking at the safety actuation device 40, while those with the designation “b” are generally to the right. A controller (not shown) is in electrical communication with each electromagnetic actuators 42a, 42b and is configured to control a supply/or elimination of electricity to the electromagnetic actuators 42a, 42b to cause their actuation. The controller employs various signals and inputs to determine whether or not to actuate the electromagnetic actuators 42a, 42b and thereby engage the safety brake 24.

In operation, if the elevator car 16 reaches an over-speed condition, the elevator drive is commanded to stop and otherwise applies the brake to arrest movement of the drive sheave (not shown) and thereby arrest movement of elevator car 16. As described above, with the safety actuation device 40 described herein, if, however, the elevator car 16 continues to experience an over speed condition, the safety actuation device 40 then acts to trigger the safety brake 24 to engage guide rails 20 to arrest movement of elevator car 16. In an embodiment, the controller receives various elevator parameters including the position or speed of the elevator car 16 as it moves in the hoistway. The controller actuates the safety actuation device 40 if the parameters satisfy a selected set of conditions. For example, the position or speed of the elevator car exceeds a selected threshold.

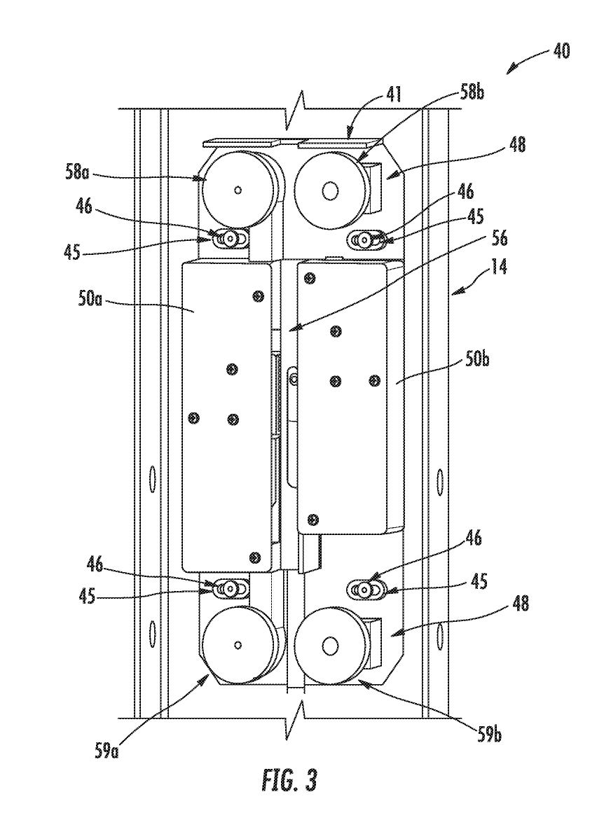

Continuing with FIG. 2, and looking to FIG. 3 as well, the mounting plate 41 includes at least one aperture 45 disposed therein for mounting the safety actuation device 40 to the car frame 14. The apertures 45 on the mounting plate 41 and the fasteners 46 fixed on the car frame 14 allow a safety actuation device 40 to float horizontally (i.e., the mounting plate can slide front to back relative to the car frame 14 and elevator car 16 in the hoistway) when there is position variation between the elevator car 16 and the guide rail 20 (not shown, see FIG. 1). Typically such position variations occur during an elevator normal run as well as when actuating and resetting the safety brake 24. The safety actuation device 40 further includes a channel 56 extending substantially perpendicular from the mounting plate 41, and configured to surround the guide rail 20. The guide rail 20 is disposed within the channel 56.

A first guide member 58a, 59a and a second guide member 58b, 59b may be positioned above and/or below the two housings 50a and 50b and positioned to each side of the channel 56. The guide rail 20 (not shown for clarity, see FIG. 1) is disposed within the channel 56 with the first guide member 58a, 59a and the second guide member 58b, 59b engaged with the guide rail 20 to minimize the impact of position variations between the safety actuation device 40 and the guide rail 20. While in an embodiment the guide members 58a, 58b, 59a, and 59b are depicted and further discussed as rollers, it should be appreciated that any configuration that can substantially align the channel 56 and thereby, the safety actuation device 40 with the guide rail 20 could be employed. For example, slide guides, shoes, rollers, bearings, and the like. It should also be appreciated that a mix of types of devices for the guide members 58a, 58b, 59a, 59b could be employed, for example slide guides in some applications with rollers in others. It should therefore be appreciated that the present embodiments include a mounting assembly shown generally as 48 having at least one guide member, in this instance first guide member 58a, 59a and second guide member 58b, 59b disposed about channel 56, or alternatively at least one guide member 58a, 58b, 59a, 59b is affixed to the mounting plate 41 to substantially align the channel 56 of the safety actuation device 40 horizontally with respect to the guide rail 20 to improve the performance of safety actuation and reset due to the minimized position variations, (i.e., front to back) between the safety actuation device 40 and the guide rail 20.

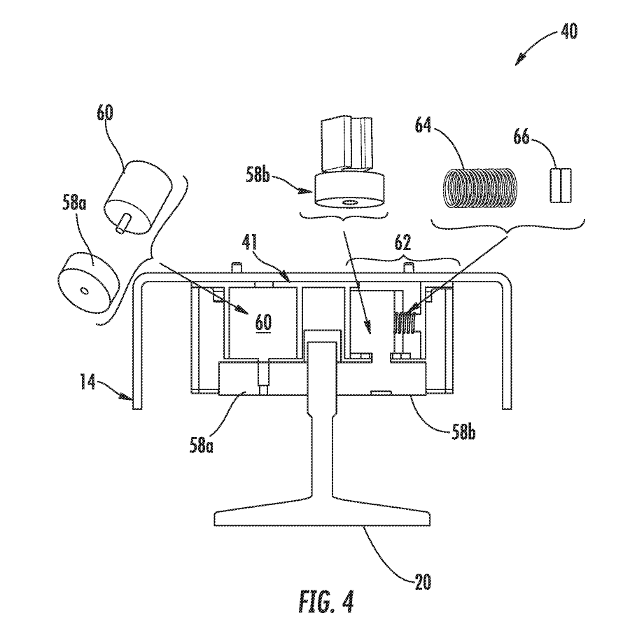

Continuing with FIG. 3 and turning now to FIG. 4 as well, FIG. 3 depicts a partial view of the safety actuation device 40 in accordance with an embodiment. FIG. 4 depicts a partially exploded cutaway view of the upper portion of safety actuation device 40 disposed with a guide rail 20 shown looking downward. In this view only the guide members 58a and 58b and associated components are visible. It should be understood that a similar set of components is employed on a lower portion of the safety actuation device 40 in association with guide members 59a and 59b. In an embodiment, the safety actuation device 40 also includes one or more position encoders 60, 61 (second encoder 61 not shown as it is on the lower part of the safety actuation device 40 not seen in the view of FIG. 4) integrated with guide member 59a (also not shown). In this embodiment, in operation, the guide members 58a, 59a are rollers, rubber rings, wheels, or the like disposed in contact with and configured to maintain contact with the guide rail 20 as will be described further herein. In an embodiment the encoders 60, 61 are disposed on, and in, a fixed arrangement on the mounting plate 41 of the safety actuation device 40 and operably coupled with the guide member 58a, and 58b respectively. Conversely, guide members 58b, and 59b are roller guides, slide guides, and the like. In an embodiment roller guides are employed. The position encoder(s) 60, 61 may be of any conventional configuration suitable for the application. In an embodiment rotary optical encoders are employed. In other embodiments, any electromagnetic position transducer may be employed, such as synchros, resolvers, rotary variable differential transformers, hall-effect sensors and the like. The encoders 60, 61 are operably connected to the controller to facilitate the determination as needed to actuate the electromagnetic actuators 42a, 42b of the safety actuation device 40 as required.

In an embodiment, the safety actuation device 40 is also configured with a preload mechanism 62, 63 (63 also not shown) disposed on the mounting plate 41. The guide members 58b, 59b (also not shown in this view) and slidingly engaged, horizontally, with the preload mechanism 62, 63 and configured to maintain a force against the guide members 58b, 59b and to guiderail 20 respectively and thereby displacing the safety actuation device 40 (horizontally) to move within the apertures 45 on fasteners 46 to maintain reliable mating contact between the guide members 58a, 58b, and 59a, 59b with the guide rail 20 as the elevator car 16 (or the counterweight) moves. In this manner, the guide members 58a and 59a (i.e. with the mini-rotary encoder and roller) are forced to maintain contact with the guide rail 20 and thus rotate by relative motion (vertical in the hoistway) between the safety actuation device 40 and the guide rail 20 as the elevator car 16 moves. That is, the force provided by the preload mechanism 62, 63 (e.g., provided by spring 64, 65 (65 not depicted), or opposing magnet set 66, 67 (67 not shown), and the like, ensures reliable mating contact between the guide members 58a, 58b as well as 59a, 59b and the guide rail 20. While springs and magnets have been described with respect to the mechanism that provides the actuation force in the preload mechanism 62, (63), it should be appreciated that such description is merely illustrative. For example, pneumatics, hydraulics, or any other known method may be used. Any configuration of devices that provides a loading force to ensure that the guide members 58a and 58b, as well as 59a and 59b maintain contact with the guide rail 20 should be understood as within the scope of the described embodiments.

The safety actuation device 40 is floating (at least horizontally) with respect to the car (counterweight) frame 14 via apertures 45 (FIG. 3) on the mounting plate 41. The fasteners 46 (FIG. 3) are fixed on the car frame 14 allow a safety actuation device 40 to float horizontally when there is position variation between the elevator car 16 and the guide rail 20. The tightly maintained contact between the guide members 58a, 58b as well as 59a, 59b, with the guide rail 20 ensures that the rotary encoders 60, 61 are reliably and accurately sensing the motion of the safety actuation device, and thereby the elevator car 16 as it travels through the hoistway. In addition because of the described configuration, with two encoders 60, 61 and preload mechanisms 62 63, improved contact with the guide rail 20 is ensured, such redundancy in speed sensing provides for greater reliability and thereby extended speed detection range (e.g., low speed to high speed) is assured.

Another advantage to the speed detection mechanism of an embodiment is the improved flexibility for system integration over existing designs, also the system integration cost is independent of the building rise making it highly advantageous for high-rise or multicar ropeless applications.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

What is claimed is:

1. A speed detection device for a braking device for an elevator system including an elevator car and a guide rail configured to operate in a hoistway, the speed detection device comprising:
a safety actuation device having a first guide member disposed on a mounting plate of the safety actuation device and a second guide member disposed on the mounting plate, the first guide member and the second guide member in operable communication with the guide rail as the elevator car moves along the guide rail in the hoistway, wherein the mounting plate is slidingly engaged in a horizontal axis with a car frame of the elevator car;
a first rotary encoder disposed on the mounting plate and operably connected to the first guide member; and
a preload mechanism operably engaged with the second guide member and configured to slidingly displace the second guide member and the safety actuation device so that the second guide member and the first guide member maintain contact with the guide rail.

2. The speed detection device of claim 1 further including a third guide member disposed on the mounting plate of the safety actuation device and a fourth guide member disposed on the mounting plate, the third guide member and the fourth guide member in operable communication with the guide rail as the elevator car moves along the guide rail in the hoistway.

3. The speed detection device of claim 2 further including a second rotary encoder disposed on the mounting plate and operably connected to the third guide member.

4. The speed detection device of claim 3 further including a second preload mechanism operably engaged with the fourth guide member and configured to slidingly displace the fourth guide member and the safety actuation device so that the fourth guide member and the third guide member maintain contact with the guide rail.

5. The speed detection device of claim 2 wherein the third guide member and the fourth guide member are displaced vertically on the safety actuation device from the first guide member and the second guide member.

6. The speed detection device of claim 1 wherein the first guide member is a roller.

7. The speed detection device of claim 1 wherein the second guide member is at least one of a roller and a slide.

8. The speed detection device of claim 1 wherein the first rotary encoder is at least one of electromagnetic and optical.

9. The speed detection device of claim 1 wherein the preload mechanism includes at least one of a spring and a magnetic assembly.

10. The speed detection device of claim 1 wherein the safety actuation device floats horizontally with respect to the elevator car.

11. A braking device for an elevator system including an elevator car and a guide rail configured to operate in a hoistway, the device comprising:
a safety brake disposed on the car and adapted to be wedged against the guide rail when moved from a non-braking state into a braking state;
a safety actuation device disposed on the elevator car, the safety actuation device including;
a first electromagnetic actuator and a second electromagnetic actuator, the first electromagnetic actuator and the second electromagnetic actuator operably coupled to the safety brake, wherein actuation of at least one of the first electromagnetic actuator and the second electromagnetic actuator causes movement of the safety brake from the non-braking state into the braking state,
a first guide member disposed on a mounting plate of the safety actuation device and a second guide member disposed on the mounting plate, the first guide member and the second guide member in operable communication with the guide rail as the elevator car moves along the guide rail in the hoistway, wherein the mounting plate is slidingly engaged in a horizontal axis with a car frame of the elevator car,
a first encoder disposed on the mounting plate and operably connected to the first guide member, the first encoder configured to measure the displacement of the safety actuation device and thereby the elevator car as the elevator car moves along the guide rail in the hoistway, and
a preload mechanism operably engaged with the second guide member and configured to slidingly displace the second guide member and the safety actuation device so that the second guide member and the first guide member maintain contact with the guide rail; and
a controller in operable communication with at least one of the first electromagnetic actuator as well as the first encoder, the controller responsive to the encoder and configured to provide an actuation command to at least one of the first electromagnetic actuator and second electromagnetic actuator.

12. The braking device of claim 11 further including a third guide member disposed on the mounting plate of the safety actuation device and a fourth guide member disposed on the mounting plate, the third guide member and the fourth guide member in operable communication with the guide rail as the elevator car moves along the guide rail in the hoistway.

13. The braking device of claim 12 further including a second rotary encoder disposed on the mounting plate and operably connected to the third guide member.

14. The braking device of claim 13 further including a second preload mechanism operably engaged with the fourth guide member and configured to slidingly displace the fourth guide member and the safety actuation device so that the fourth guide member and the third guide member maintain contact with the guide rail.

15. The braking device of claim 12 wherein the third guide member and the fourth guide member are displaced vertically on the safety actuation device from the first guide member and the second guide member.

16. An elevator system comprising:
a hoistway;
a guide rail disposed in the hoistway;
a car operably coupled to the guide rail by a car frame for upward and downward travel in the hoistway;
a safety brake disposed on the car and adapted to be wedged against the guide rail when moved from a non-braking state into a braking state;
a safety actuation device disposed on the elevator car, the safety actuation device including:
a first electromagnetic actuator and a second electromagnetic actuator, the first electromagnetic actuator and the second electromagnetic actuator operably coupled to the safety brake, wherein actuation of at least one of the first electromagnetic actuator and the second electromagnetic actuator causes movement of the safety brake from the non-braking state into the braking state;
a first guide member disposed on a mounting plate of the safety actuation device and a second guide member disposed on the mounting plate, the first guide member and the second guide member in operable communication with the guide rail as the elevator car moves along the guide rail in the hoistway, wherein the mounting plate is slidingly engaged in a horizontal axis with a car frame of the elevator car;
a first encoder disposed on the mounting plate and operably connected to the first guide member, the first encoder configured to measure the displacement of the safety actuation device and thereby the elevator car as the elevator car moves along the guide rail in the hoistway; and
a preload mechanism operably engaged with the second guide member and configured to slidingly displace the second guide member and the safety actuation device so that the second guide member and the first guide member maintain contact with the guide rail.
a controller in operable communication with at least one of the first electromagnetic actuator as well as the first encoder, the controller responsive to the encoder and configured to provide an actuation command to at least one of the first electromagnetic actuator and second electromagnetic actuator.
